(19) United States
(12) Patent Application Publication
(10) Pub. No.: US 2021/0075256 A1
(43) Pub. Date: Mar. 11, 2021

(54) ELECTRONIC-DEVICE HOLDING APPARATUS AND ELECTRONIC-DEVICE HOLDING SUCTION APPARATUS

(71) Applicant: HURKINS CO., LTD., Daegu (KR)

(72) Inventor: Ji Uk HUR, Seoul (KR)

(21) Appl. No.: 16/610,437

(22) PCT Filed: Oct. 22, 2019
(86) PCT No.: PCT/KR2019/013887

§ 371 Date: Nov. 1, 2019

(30) Foreign Application Priority Data
Mar. 8, 2019 (KR) 10-2019-0027056
Sep. 30, 2019 (KR) 10-2019-0120463

(51) Int. Cl. H02J 50/00; F16B 47/00; H02J 50/10; H04M 1/04; H02J 50/90; F16C 11/06

(52) U.S. Cl. CPC H02J 50/005; F16B 47/00; F16C 11/06; H04M 1/04; H02J 50/90; H02J 50/10

(57) ABSTRACT

Provided is an electronic-device holding apparatus that holds an electronic device such as a smartphone, reduces vibration of the electronic device even when a user's hand operates the electronic device while touching the electronic device, and stably holds the electronic device at a changed position even when a position of the held electronic device changes. The electronic-device holding apparatus includes: a charging head unit that is selectively coupled to or uncoupled from an electronic device and charges the electronic device in a wireless charging manner when being coupled to the electronic device; a support module that is selectively coupled to or uncoupled from the charging head unit, secures and supports the charging head unit when being coupled to the charging head unit, and has at least one joint so as to change a shape depending on a change in three-dimensional position of the charging head unit; and a support that is coupled to the support module to support the support module and restrains the support module while the support module performs a tilting movement.

### TECHNICAL FIELD

The present invention relates to an electronic-device holding apparatus and an electronic-device suction apparatus, and more specifically, a holding apparatus that holds an electronic device such as a smartphone, reduces vibration of the electronic device even when a user's hand operates the electronic device while touching the electronic device, and stably holds the electronic device at a changed position even when a position of the held electronic device changes and a suction apparatus used in the holding apparatus.

### BACKGROUND ART

As smartphones are widely used, population using the smartphones increases, and a smartphone time of a smartphone user also increases in proportional to the increase in population. A smartphone user uses a smartphone in various postures, and there is a continuous increase in demand for using a smartphone in a comfortable posture of a user by securing the smartphone to a separate apparatus without directly gripping the smartphone by the user's hand.

Various apparatuses that hold smartphones are developed and are commercially available; however, a problem arises in that the smartphone holding device in the related art will cause the smartphone to vibrate when a user touches the smartphone, or there will be a limit on a free change in position of the smartphone.

Korea Patent No. 10-1621187 (Title of the Invention: SMARTPHONE HOLDER) discloses a smartphone holder including: a base that has a battery accommodating space, a charging PCB installed in the battery accommodating space, a female connector which is electrically connected to the charging PCB, and a charging hole which houses the female connector; a smartphone holding unit that has a support which is extended from one side of the base and is freely bent in multiple directions and a gripper that is installed at an upper end portion of the support and grips a mobile phone; and a battery that is accommodated in the battery accommodating space and is connected to the charging PCB.

### SUMMARY OF INVENTION

### Technical Problem

In order to solve the problem described above, an object of the present invention is to reduce vibration of an electronic device even when the electronic device such as a smartphone is held by a holding apparatus and a user's hand operates the electronic device while touching the electronic device.

In addition, another object of the present invention is to stably hold the electronic device at a changed position even when a position of the electronic device held by a holding apparatus changes.

Technical objects to be achieved by the present invention are not limited to the technical objects mentioned above, and the following description enables other unmentioned technical objects to be clearly understood by a person of ordinary skill in the art to which the present invention belongs.

### Solution to Problem

In order to achieve the object described above, the present invention is configured to include: a charging head unit that is selectively coupled to or uncoupled from an electronic device and charges the electronic device in a wireless charging manner when being coupled to the electronic device; a support module that is selectively coupled to or uncoupled from the charging head unit, secures and supports the charging head unit when being coupled to the charging head unit, and has at least one joint so as to change a shape depending on a change in three-dimensional position of the charging head unit; and a support that is coupled to the support module to support the support module and restrains the support module while the support module performs a tilting movement. The support includes a double-core coil formed by coupling one spring coil to another spring coil at an outer side of one portion of the one spring coil.

According to an example of the present invention, the charging head unit may include a charging pad of which one portion is selectively coupled to or uncoupled from the electronic device and which receives electric power from outside and wirelessly supplies the electric power to the electronic device, and a pad coupling member which is coupled to another portion of the charging pad, has a spherical shape, and is selectively coupled to or uncoupled from the support module.

According to the example of the present invention, the charging head unit may further include a suction pad that is coupled to the charging pad and vacuum-suctions the electronic device.

According to the example of the present invention, the support module may further include a first support which has a pipe shape and of which one end is connected to the charging head unit and another end is coupled to the joint, and a second support which has a pipe shape and of which one end is coupled to the joint and another end is coupled to the support.

According to the example of the present invention, the joint may include a joint housing which is coupled to the first support and has an internal space, and a joint coupling member which is coupled to the second support, has a spherical shape, and is led into the internal space of the joint housing.

According to the example of the present invention, the support module may further include a first cable which is formed to penetrate the first support, the second support, and the joint, a second cable which is connected to the first cable and is selectively coupled to and uncoupled from the charging head unit, and a cable unit that transmits electric power.

According to the example of the present invention, the support may further include a support housing into which the double-core coil is led, a support coupling member which is coupled to the support module, has a spherical shape, and is led into an internal space of the support housing, and an elastic support member which is formed in the internal space of the support housing to surround one portion of the support coupling member and has elasticity.

According to the example of the present invention, another portion of one spring coil that configures the double-core coil may be led into the support coupling member.

The example of the present invention may further include a base unit that is coupled to the support and is installed on a predetermined object to secure and support the support.

According to the example of the present invention, the base unit may include a first base member which is coupled to the support and has an internal space, a second base member which is led into the internal space of the first base member to be coupled to the first base member such that a length of a portion that is exposed outside is variable and which has a plurality of slits, and a toggle clamp which is coupled to the first base member, is selectively coupled to any one slit of the plurality of slits, and secures the second base member.

Another example of the present invention includes: a charging head unit having a flat surface; and a suction pad that is coupled to the flat surface of the charging head unit, has a plurality of suction layers which are brought into press contact with one surface of a target object which is an object as a holding target, and vacuum-suctions and supports the target object. Of the plurality of suction layers of the suction pad, one suction layer is surrounded by another suction layer such that the plurality of suction layers form a shape of concentric circles of the suction layers at regular intervals.

According to the other example of the present invention, any one suction layer of the plurality of suction layers may have an external shape of which an inner surface and an outer surface are inclined in different directions from each other and which is a cylindrical shape having a height smaller than a longest outer circumferential length.

According to the other example of the present invention, the suction pad may be made of a material having elasticity.

According to the other example of the present invention, the charging head unit may wirelessly supply electric power to the target object when the target object is supported by being suction-coupled to the suction pad.

### Advantageous Effects of Invention

According to the configuration described above, the present invention achieves the following effects. By forming the double-core coil and the elastic support member at the support, even when a user operates the electronic device such as a smartphone, and generates vibration, the vibration of the support module or the like is absorbed so as to reduce the vibration to the smallest extent while the electronic device is used.

Besides, a force to resist against the tiling movements is applied against the tiling movements of the charging head unit and the support module, due to an elastic force, a frictional force, and a magnetic force, and thereby the tiling movements of the charging head unit and the support module are easily performed, and the electronic device is easily held.

In addition, the suction pad configured of the plurality of suction layers is coupled to the charging head unit, and the electronic device is secured by using the suction pad. Hence, it is possible to easily suction-secure electronic devices having various weights.

Effects of the present invention are construed not to be limited to the above-mentioned effects but to include every effect that can be derived from configurations of the invention described in the detailed description and claims of the present invention.

### BRIEF DESCRIPTION OF DRAWINGS

FIG. 1 is a perspective view of an electronic-device holding apparatus according to an example of the present invention.

FIG. 2 is a side view of the electronic-device holding apparatus according to the example of the present invention.

FIG. 3 is a sectional view of the electronic-device holding apparatus according to the example of the present invention.

FIG. 4 is a schematic view of a charging head unit according to the example of the present invention.

FIG. 5 is a schematic view of a charging head unit according to another example of the present invention.

FIG. 6 is a sectional view of the charging head unit according to the other example of the present invention.

FIG. 7 is a sectional view of a joint according to an example of the present invention.

FIG. 8 is a schematic view of an internal structure of a support according to the example of the present invention.

FIG. 9 is a sectional view of a support according to the example of the present invention.

FIG. 10 is a perspective view of a base unit according to the example of the present invention.

### DESCRIPTION OF EMBODIMENTS

Hereinafter, the present invention will be described with reference to the accompanying drawings. However, the present invention can be realized as various different embodiments and, thus, is not limited to examples described here. Besides, a part irrelevant to the description is omitted from the drawings in order to clearly describe the present invention, and similar reference signs are assigned to similar parts through the entire specification.

In the entire specification, when a certain part is “connected to (access, in contact with, or coupled to)” another part, this includes not only a case where the parts are “directly connected” to each other, but also a case where the parts are “indirectly connected” to each other with another member interposed therebetween. In addition, when a certain part “includes” a certain configurational element, this means that another configurational element is not excluded, but the configurational element can be further included, unless specifically described otherwise.

Terms used in this specification are only used to describe a specific example and are not intentionally used to limit the present invention. A singular form includes a plural form, unless obviously implied otherwise in context. In this specification, a term such as “to include” or “to have” is construed to specify that a feature, a number, a step, an operation, a configurational element, a part, or an assembly thereof described in the specification is present and not to exclude presence or a possibility of addition of one or more other features, numbers, steps, operations, configurational elements, parts, or assemblies thereof in advance.

Hereinafter, the present invention will be described in detail with reference to the accompanying drawings.

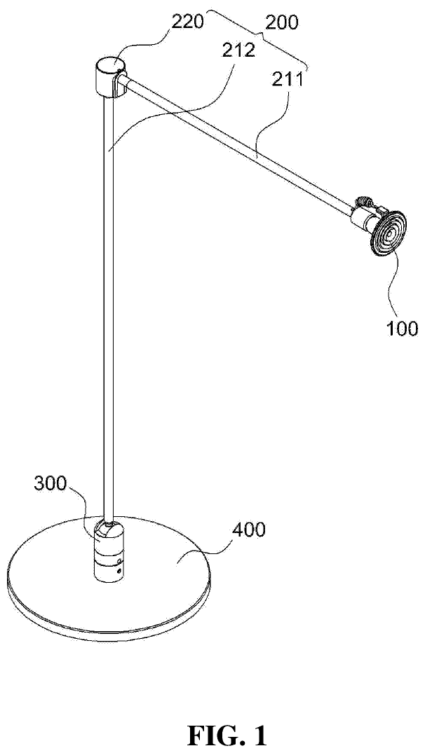

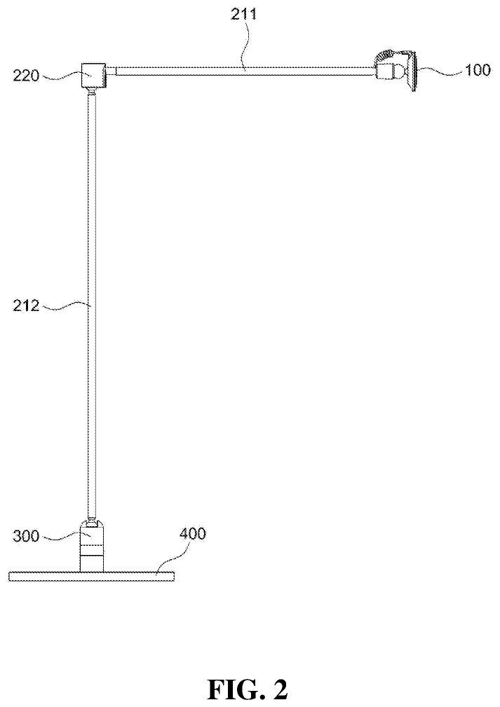

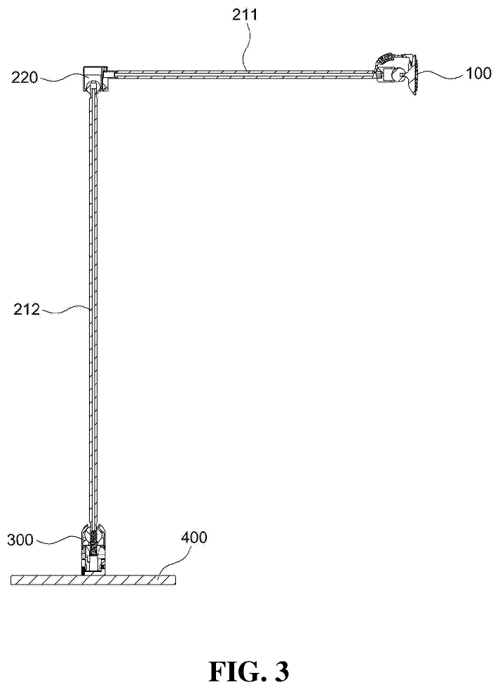

FIG. 1 is a perspective view of an electronic-device holding apparatus according to an example of the present invention. FIG. 2 is a side view of the electronic-device holding apparatus according to the example of the present invention. FIG. 3 is a sectional view of the electronic-device holding apparatus according to the example of the present invention.

As shown in FIGS. 1 to 3, the electronic-device holding apparatus includes: a charging head unit 100 that is selectively coupled to or uncoupled from an electronic device and charges the electronic device in a wireless charging manner when being coupled to the electronic device; a support module 200 that is selectively coupled to or uncoupled from the charging head unit 100, secures and supports the charging head unit 100 when being coupled to the charging head unit 100, and has at least one joint 220 so as to change a shape depending on a change in three-dimensional position of the charging head unit 100; and a support 300 that is coupled to the support module 200 to support the support module 200 and restrains the support module 200 while the support module 200 performs a tilting movement. Here, the tilting movement can mean an inclined movement at a predetermined angle. The electronic device can be a portable electronic device such as a smartphone, a tablet PC, or an electronic book.

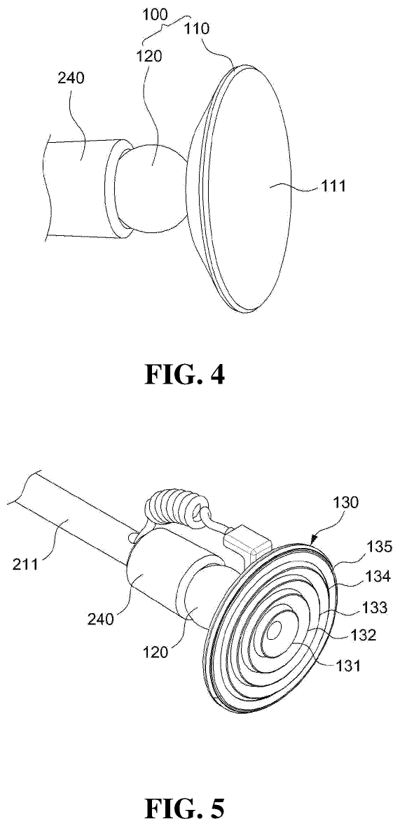

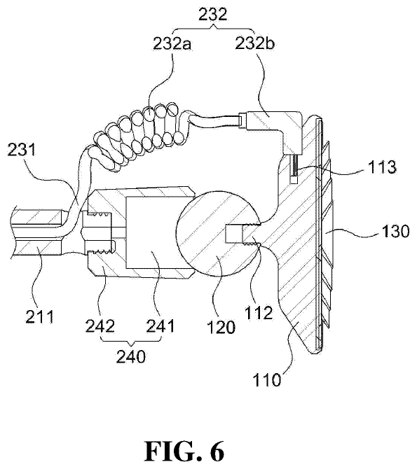

FIG. 4 is a schematic view of the charging head unit 100 according to the example of the present invention. FIG. 5 is a schematic view of the charging head unit 100 according to another example of the present invention. FIG. 6 is a sectional view of the charging head unit 100 according to the other example of the present invention. Here, a suction pad 130 is not coupled to a charging pad 110 in FIG. 4, and the suction pad 130 is coupled to the charging pad 110 in FIGS. 5 and 6.

As shown in FIGS. 4 to 6, the charging head unit 100 can include the charging pad 110 of which one portion is selectively coupled to or uncoupled from the electronic device and which receives electric power from outside and wirelessly supplies the electric power to the electronic device, and a pad coupling member 120 which is coupled to another portion of the charging pad 110, has a spherical shape, and is selectively coupled to or uncoupled from the support module 200. Here, the charging pad 110 can be formed to project from one portion of the charging pad 110 and can have a pad projecting member 112 that is coupled to the pad coupling member 120.

As shown in FIG. 6, one end of a first support 211 of the support module 200 can have a charging-head coupling member 240 which is selectively coupled to or uncoupled from the charging head unit 100 with a magnetic force.

The charging-head coupling member 240 can include a magnetic head member 241 which is made of a magnet, has a curved surface as a surface that comes into contact with the pad coupling member 120, and is attachable to and detachable from the pad coupling member 120 and a magnet-head-member housing 242 which is coupled to the first support 211 and has an internal space having a shape corresponding to the magnetic head member 241 such that the magnet head member 241 is led into the internal space. The magnet-head-member housing 242 can be securely coupled to the first support 211. Specifically, the magnet-head-member housing 242 can be coupled to the first support 211 by screwing.

Since the surface of the magnetic head member 241 is formed as a curved surface, when the pad coupling member 120 and the magnetic head member 241 is coupled by magnetic force, the spherical pad coupling member 120 can perform a rotational movement, and thus it is possible to change a direction of a charging surface 111 of the charging pad 110 which is brought into contact with or approaches the electronic device to transmit electric power.

Besides, since the charging-head coupling member 240 and the charging head unit 100 can be uncoupled from each other, a user can uncouple the charging head and can move to couple the uncoupled charging head unit 100 to another device that has another magnetic head member 241 having the same shape as that of the magnetic head body 241.

A magnet is attached to the electronic device such that the charging pad 110 can be coupled to the electronic device with a magnetic force, or a configuration having a shape of forceps that tighten and hold the electronic device may be coupled to the charging head unit 100 to tighten and hold the electronic device such that the charging pad 110 can be coupled to the electronic device; however, as will be described below, the electronic device can be held to approach the charging pad 110 by using the suction pad 130.

As shown in FIGS. 5 and 6, the charging head unit 100 can further include the suction pad 130 that is coupled to the charging pad 110 and vacuum-suctions the electronic device. Here, the suction pad 130 can have at least one suction layer. The suction pad 130 can be made of a material having elasticity. Specifically, the suction pad 130 can be made of rubber or a synthetic resin. However, a material of the suction pad is not limited thereto.

Any one suction layer of the plurality of suction layers can have an external shape of which an inner surface and an outer surface are inclined in different directions from each other and which is a cylindrical shape having a height smaller than a longest outer circumferential length. Besides, a triangular internal space can be formed between the inner surface and the outer surface of a side wall of the one suction layer. In other words, the suction layer can have a shape formed by disposing triangles without base at predetermined distances in an annular shape around a central axis of the suction pad 130, the central axis penetrating a center of the suction pad 130 and being perpendicular to the charging surface 111.

In addition, one suction layer can be surrounded by another suction layer, and thus the plurality of suction layers form a shape of concentric circles of the suction layers at regular intervals, when the suction pad 130 is viewed in a direction in which the suction pad comes into contact with the electronic device.

Contact portions of the suction layer can be positioned to have different distances from the charging surface 111. Here, the contact portion of the suction layer can mean one portion of a suction layer which is brought into contact with one surface of the electronic device that is secured and supported by the suction pad 130.

Specifically, a contact portion of a suction layer positioned at the center at the suction pad 130 can be formed at a position which is relatively most separated position from the charging surface 111, and a contact portion of a suction layer positioned at the outer-most position at the suction pad 130 can be formed at a position which is relatively closest to the charging surface 111.

As shown in FIGS. 5 and 6, as an example of the suction pad 130, the suction pad 130 can include first to fifth suction layers 131 to 135, the second suction layer 132 is formed to surround the first suction layer 131 positioned at the center, and formation of suction layers as described above is repeatedly performed such that, finally, the fifth suction layer 135 can be formed to surround a fourth suction layer 134.

Besides, the first to fifth suction layers 131 to 135 are formed to have shapes described above, the contact portion of the first suction layer 131 can be formed at a position which is most separated from the charging surface 111, and it is possible to form the suction layers such that contact portions of the suction layers are arranged at positions that approach the charging surface 111 gradually from the second suction layer 132 toward the fifth suction layer 135. Hence, when one surface of the electronic device is brought into contact with the suction pad 130, the first suction layer 131 is first brought into contact with the one surface of the electronic device and the fifth suction layer 135 is last brought into contact with the one surface of the electronic device.

In the example of the present invention, the positions of the first to fifth suction layers 131 to 135 are described to be formed as described above; however, the positions are not always limited thereto, and the positions of the suction portions of the suction layers can be differently disposed. Specifically, the positions of the contact portions of the suction layers can be formed at the same positions or cannot be formed sequentially as described above so as to be formed at different positions from each other.

With a configuration of the suction pad 130 as described above, when the one surface of the electronic device is brought into contact with the suction pad 130 and is pressed against the suction pad, vacuum-suction is performed in multi-steps with the plurality of suction layers so as to easily support and hole electronic devices with various weight.

The support module 200 can further include a first support 211 which has a pipe shape and of which one end is connected to the charging head unit 100 and the other end is coupled to the joint 220, and a second support 212 which has a pipe shape and of which one end is coupled to the joint 220 and the other end is coupled to the support 300. Besides, the first support 211 and the second support 212 can be formed in a pipe having a circular or polygonal cross section. When a plurality of joints 220 are provided, the number of supports such as the first support 211 and the second support 212 can increase. However, for convenience of description, in the example of the present invention, a case of providing one joint 220 is described.

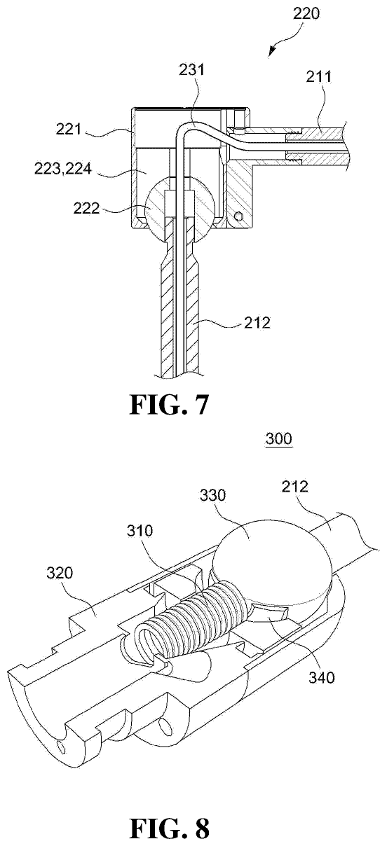

FIG. 7 is a sectional view of the joint 220 according to the example of the present invention. As shown in FIG. 7, the joint 220 can include a joint housing 221 which is coupled to the first support 211 and has an internal space, and a joint coupling member 222 which is coupled to the second support 212, has a spherical shape, and is led into the internal space of the joint housing 221.

Here, the joint housing 221 can be coupled to the other end of the first support 211, and the joint coupling member 222 can be coupled to one end of the second support 212. Besides, a magnetic joint member 223 which is formed by a magnet, of which a surface that is brought into contact with the joint coupling member 222 is a curved surface, and which secures the joint coupling member 222 with the magnetic force can be formed in the internal space of the joint housing 221. The joint housing 221 can be securely coupled to the first support 211. Specifically, the joint housing 221 can be coupled to the first support 211 by screwing.

The surface of the joint coupling member 223 which is brought into contact with the joint coupling member 222 is a curved surface. Hence, when the joint coupling member 222 and the magnetic joint member 223 are coupled to each other with the magnetic force, the spherical joint coupling member 222 can perform a rotational movement, and thus it is possible to change relative three-dimensional positions of the first support 211 and the second support 212 by the relative tilting movement of the first support 211 and the second support 212 depending on an operation by a user, and the first support 211 and the second support 212 with changed positions can be secured due to the magnetic force of the magnetic joint member 223 and the joint coupling member 222 described above.

Besides, a joint fixture 224 can be formed in the internal space of the joint housing 221, the joint fixture being made of rubber or a synthetic resin having elasticity and having a surface which is brought into contact with the joint coupling member 222 as a curved surface, and which secures the joint coupling member 222 with the magnetic force.

In this manner, when the magnetic joint member 223 is not formed, but the joint fixture 224 is formed, the spherical joint coupling member 222 can perform the rotational movement, and thus it is possible to change three-dimensional positions of the first support 211 and the second support 212 by the relative tilting movements of the first support 211 and the second support 212 depending on an operation by a user, and the first support 211 and the second support 212 with changed positions can be secured due to the frictional force of the joint fixture 224 and the joint coupling member 222. Besides, the joint fixture 224 having elasticity can also have magnetism, and in this case, the joint fixture 224 can perform a function realized by the magnetic joint member 223 with the magnetic force of the joint fixture 224.

As shown in FIG. 6, the support module 200 can further include a first cable 231 which is formed to penetrate the first support 211, the second support 212, and the joint 220, a second cable 232 which is connected to the first cable 231 and is selectively coupled to and uncoupled from the charging head unit 100, and a cable unit that transmits electric power.

The second cable 232 can have a coil-shaped member 232a which is formed by a coil-shaped electric cable and a power supply member 232b that is coupled to the charging head unit 100 so as to supply electric power to the charging head unit 100. Besides, the charging pad 110 can have a power connector 113, and the power supply member 232b can be led into the power connector 113, thereby transmitting the electric power from outside via the cable unit to the charging head unit 100.

Here, the coil-shaped member 232a enables the second cable 232 to have a variable length, and thus it is easy to adjust the length of the second cable 232 while the power supply member 232b is coupled to the charging head unit 100, and it is possible to prevent the power supply member 232b and the power connector 113 from being separated even during the tilting movement of the charging head unit 100.

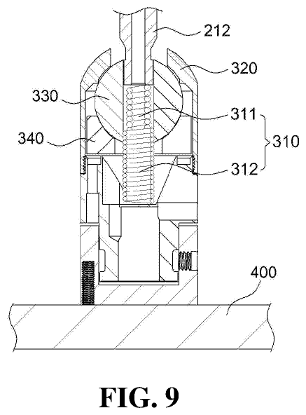

FIG. 8 is a schematic view of an internal structure of the support 300 according to the example of the present invention. FIG. 9 is a sectional view of the support 300 according to the example of the present invention. The support 300 includes a double-core coil 310 formed by coupling one spring coil to another spring coil at an outer side of one portion of the one spring coil. Besides, the support 300 can further include a support housing 320 into which the double-core coil 310 is led, a support coupling member 330 which is coupled to the support module 200, has a spherical shape, and is led into an internal space of the support housing 320, and an elastic support member 340 which is formed in the internal space of the support housing 320 to surround one portion of the support coupling member 330 and has elasticity. Besides, another portion of one spring coil that configures the double-core coil 310 may be led into the support coupling member 330. The elastic support member 340 can be made of rubber or a synthetic resin.

Specifically, as shown in FIGS. 8 and 9, the double-core coil 310 can have a first core coil 311 which has a coil shape and a relatively long length and a second core coil 312 which has a coil shape to surround one portion including a lower portion of the first core coil 311 and is relatively short. Besides, an upper portion of the first core coil 311 exposed outside and an upper portion of the second core coil 312 can be led into the internal space of the support coupling member 330, and the upper end of the second core coil 312 can be brought into contact with an inner surface of the support coupling member 330. In addition, the other end of the second support 212 can be formed to be led into the internal space of the support coupling member 330. Besides, as shown in FIG. 9, when a central axis in a length direction of the support coupling member 330 is parallel to a central axis of the support coupling member 330 which penetrates the internal space of the support coupling member 330, the first core coil 311 can be separated from the inner surface of the support coupling member 330.

Besides, when the support coupling member 330 performs the rotational movement in order to perform the tilting movement of the second support 212, and a contact-rotation angle which is a rotation angle at which the first core coil 311 and the support coupling member 330 are brought into contact with each other is smaller than a rotation angle of the support coupling member 330, a frictional force and an elastic force of the elastic support member 340 and an elastic force of the second core coil 312 are supplied to the support coupling member 330, and thereby weights of the charging head unit 100 and the support module 200 can be supported. Here, as the second core coil 312 is bent due to the rotation of the support coupling member 330, elasticity of the second core coil 312 increases, and thereby it is possible to increase a support force with respect to the second support 212.

In addition, when a rotation angle of the support coupling member 330 increases due to an increase in tilting angle of the second support 212 such that the rotation angle of the support coupling member 330 is equal to or larger than the contact-rotation angle, the frictional force and the elastic force of the elastic support member 340, an elastic force of the second core coil 312, and an elastic force of the first core coil 311 are supplied to the support coupling member 330, and thereby weights of the charging head unit 100 and the support module 200 can be supported. Here, as the first core coil 311 and the second core coil 312 are bent due to the rotation of the support coupling member 330, elasticity of the first core coil 311 and the second core coil 312 increases, and thereby it is possible to increase a support force with respect to the second support 212.

Hence, even when a load transmitted to the support 300 increases depending on an increase in tilting angle of the first support 211 and the second support 212, the elastic forces of the first core coil 311 and the second core coil 312 are sequentially supplied to the support coupling member 330, and the elastic forces of the first core coil 311 and the second core coil 312 are variable. In this manner, the support 300 can easily support the charging head unit 100 and the support module 200.

In the electronic-device holding apparatus of the present invention, the greatest load can be transmitted to the support 300. When a contact force between the elastic support member 340 and the support coupling member 330 increases in the support 300, a force to operate the support module 200 can excessively increase with the frictional forces of the elastic support member 340 and the support coupling member 330. By contrast, when the contact force between the elastic support member 340 and the support coupling member 330 decreases, it is not easy to secure the support module 200 by the support 300 due to weights of the charging head unit 100 and the support module 200. In order to prevent the support 300 from malfunctioning, the double-core coil 310 having the elastic force which is variable depending on the rotation angle of the support coupling member 330 as described above is led to be coupled to the support coupling member 330, and thereby the movement is smooth when the user moves the second support 212, and a position of the electronic device can be supported by the support module 200 even when time passes.

Besides, the elastic support member 340 is formed to be brought into contact with an area of one portion of the support coupling member 330 such that the elastic support member 340 supplies a frictional force during rotation of the support coupling member 330, and at the same time, the elastic support member 340 can absorb vibration generated by touching the electronic device that is coupled to the charging head unit 100 by the user. At the same time, the second core coil 312 or the first core coil 311 which are brought into contact with the support coupling member 330 can also absorb the vibration described above (the first core coil 311 may be selectively brought into contact with the inner surface of the support coupling member 330 depending on the tilting angle of the second support 212).

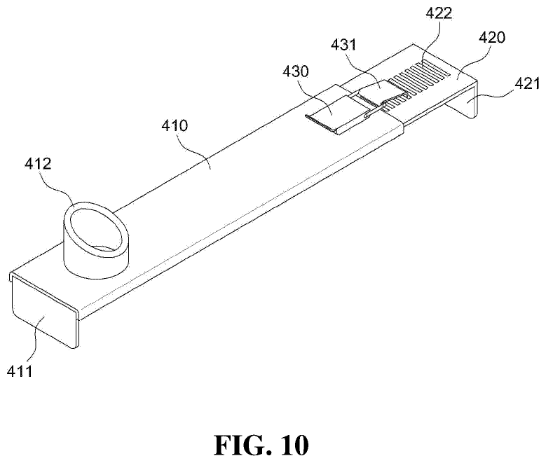

FIG. 10 is a perspective view of a base unit 400 according to the example of the present invention. The electronic-device holding apparatus of the present invention can further include a base unit 400 that is coupled to the support 300 and is installed on a predetermined object to secure and support the support 300. As shown in FIGS. 1 to 3, the base unit 400 can be formed to have a disk shape in order to simply position the support 300 at a flat surface; however, like the base unit 400 in FIG. 10, the base unit can be formed to have a shape to be secured to a plate-shaped object such as a top of a desk.

As shown in FIG. 10, the base unit 400 can include a first base member 410 which is coupled to the support 300 and has an internal space, a second base member 420 which is led into the internal space of the first base member 410 to be coupled to the first base member 410 such that a length of a portion that is exposed outside is variable and which has a plurality of slits 422, and a toggle clamp 430 which is coupled to the first base member 410, is selectively coupled to any one slit 422 of the plurality of slits 422, and secures the second base member 420. Here, the first base member 410 can have a pipe shape with a quadrangular cross section, and the second base member 420 can be formed to have a shape corresponding to the internal space of the first base member 410; however, the base units are not limited thereto. Besides, an upper surface of the first base member 410 can have a support fixture 412 that is coupled to the support 300.

The first base member 410 and the second base member 420 can respectively have a first fixture 411 and a second fixture 421 which are brought into contact with a side surface of a plate-shaped object and secure the base unit 400. The second base member 420 adjusts a length to be led into the first base member 410, and thereby the entire length of the base unit 400 is adjusted such that the first fixture 411 and the second fixture 421 can be simultaneously brought into contact with the side surface of the plate-shaped object. A ring member 431 of the toggle clamp 430, the ring member having a shape in which a terminal end is bent, is led into any one slit 422 such that the toggle clamp 430 coupled to the first base member 410 supplies a force to pull the second base member 420, and thereby the base unit 400 can be secured to the plate-shaped object while the first fixture 411 and the second fixture 421 are brought into press contact with the side surface of the plate-shaped object. Details of a principle of the toggle clamp 430 are prior art and are omitted.

According to the configurations described above, the present invention achieves the following effects. By forming the double-core coil 310 and the elastic support member 340 at the support 300, even when a user operates the electronic device such as the smartphone and generates vibration, the vibration of the support module 200 or the like is absorbed so as to reduce the vibration to the smallest extent while the electronic device is used. In addition, the force to resist against the tiling movements is applied against the tiling movements of the charging head unit 100 and the support module 200, due to the elastic force, the frictional force, and the magnetic force, and thereby the tiling movements of the charging head unit 100 and the support module 200 are easily performed, and the electronic device is easily held. Besides, the suction pad 130 configured of the plurality of suction layers is coupled to the charging head unit 100, and the electronic device is secured by using the suction pad 130. Hence, it is possible to easily suction-secure electronic devices having various weights.

The description above of the present invention is provided as an example, and a person of ordinary skill in the art to which the present invention belongs can understand that it is possible to easily modify the present invention to another embodiment without altering the technical idea or essential feature of the present invention. Therefore, the examples described above need to be understood as exemplified examples in every aspect and not as examples to limit the present invention. For example, the configurational elements described in singular forms can be realized in a distributed manner. Similarly, the configurational elements described in distributed manner may be realized in a combined manner.

The scope of the present invention needs to be construed by the claims below, and meaning and the scope of the claims and every modified or altered embodiment derived from an equivalent concept of the claims need to be construed to belong to the scope of the present invention.

### REFERENCE SIGNS LIST

100 CHARGING HEAD UNIT
110 CHARGING PAD
111 CHARGING SURFACE
112 PAD PROJECTING MEMBER
113 POWER CONNECTOR
120 PAD COUPLING MEMBER
130 SUCTION PAD
131 FIRST SUCTION LAYER
132 SECOND SUCTION LAYER
133 THIRD SUCTION LAYER
134 FOURTH SUCTION LAYER
135 FIFTH SUCTION LAYER
200 SUPPORT MODULE
211 FIRST SUPPORT
212 SECOND SUPPORT
220 JOINT
221 JOINT HOUSING
222 JOINT COUPLING MEMBER
223 MAGNETIC JOINT MEMBER
224 JOINT FIXTURE
231 FIRST CABLE
232 SECOND CABLE
232a COIL-SHAPED MEMBER
232b POWER SUPPLY MEMBER
240 CHARGING-HEAD COUPLING MEMBER
241 MAGNETIC HEAD MEMBER
242 MAGNETIC-HEAD-MEMBER HOUSING
300 SUPPORT
310 DOUBLE-CORE COIL
311 FIRST CORE COIL
312 SECOND CORE COIL
320 SUPPORT HOUSING
330 SUPPORT COUPLING MEMBER
340 ELASTIC SUPPORT MEMBER
400 BASE UNIT
410 FIRST BASE MEMBER
411 FIRST FIXTURE
412 SUPPORT FIXTURE
420 SECOND BASE MEMBER
421 SECOND FIXTURE
422 SLIT
430 TOGGLE CLAMP
431 RING MEMBER

1. An electronic-device holding apparatus comprising:
a charging head unit that is selectively coupled to or uncoupled from an electronic device and charges the electronic device in a wireless charging manner when being coupled to the electronic device;
a support module that is selectively coupled to or uncoupled from the charging head unit, secures and supports the charging head unit when being coupled to the charging head unit, and has at least one joint so as to change a shape depending on a change in three-dimensional position of the charging head unit; and
a support that is coupled to the support module to support the support module and restrains the support module while the support module performs a tilting movement,
wherein the support includes a double-core coil formed by coupling one spring coil to another spring coil at an outer side of one portion of the one spring coil.

2. The electronic-device holding apparatus according to claim 1,
wherein the charging head unit includes:
a charging pad of which one portion is selectively coupled to or uncoupled from the electronic device and which receives electric power from outside and wirelessly supplies the electric power to the electronic device, and
a pad coupling member which is coupled to another portion of the charging pad, has a spherical shape, and is selectively coupled to or uncoupled from the support module.

3. The electronic-device holding apparatus according to claim 2,
wherein the charging head unit further includes a suction pad that is coupled to the charging pad and vacuum-suctions the electronic device.

4. The electronic-device holding apparatus according to claim 1,
wherein the support module further includes
a first support which has a pipe shape and of which one end is connected to the charging head unit and another end is coupled to the joint, and
a second support which has a pipe shape and of which one end is coupled to the joint and another end is coupled to the support.

5. The electronic-device holding apparatus according to claim 4,
wherein the joint includes:
a joint housing which is coupled to the first support and has an internal space, and
a joint coupling member which is coupled to the second support, has a spherical shape, and is led into the internal space of the joint housing.

6. The electronic-device holding apparatus according to claim 4,
wherein the support module further includes a first cable which is formed to penetrate the first support, the second support, and the joint, a second cable which is connected to the first cable and is selectively coupled to and uncoupled from the charging head unit, and a cable unit that transmits electric power.

7. The electronic-device holding apparatus according to claim 1,
wherein the support includes:
a support housing into which the double-core coil is led,
a support coupling member which is coupled to the support module, has a spherical shape, and is led into an internal space of the support housing, and
an elastic support member which is formed in the internal space of the support housing to surround one portion of the support coupling member and has elasticity.

8. The electronic-device holding apparatus according to claim 6,
wherein another portion of one spring coil that configures the double-core coil is led into the support coupling member.

9. The electronic-device holding apparatus according to claim 1, further comprising:
a base unit that is coupled to the support and is installed on a predetermined object to secure and support the support.

10. The electronic-device holding apparatus according to claim 1,
wherein the base includes:
a first base member which is coupled to the support and has an internal space,
a second base member which is led into the internal space of the first base member to be coupled to the first base member such that a length of a portion that is exposed outside is variable and which has a plurality of slits, and
a toggle clamp which is coupled to the first base member, is selectively coupled to any one slit of the plurality of slits, and secures the second base member.

11. An electronic-device holding suction apparatus comprising:
a charging head unit having a flat surface; and
a suction pad that is coupled to the flat surface of the charging head unit, has a plurality of suction layers which are brought into press contact with one surface of a target object which is an object as a holding target, and vacuum-suctions and supports the target object,
wherein, of the plurality of suction layers of the suction pad, one suction layer is surrounded by another suction layer such that the plurality of suction layers form a shape of concentric circles of the suction layers at regular intervals.

12. The electronic-device holding suction apparatus according to claim 11,
wherein any one suction layer of the plurality of suction layers has an external shape of which an inner surface and an outer surface are inclined in different directions from each other and which has a cylindrical shape having a height smaller than a longest outer circumferential length.

13. The electronic-device holding suction apparatus according to claim 11,
wherein the suction pad is made of a material having elasticity.

14. The electronic-device holding suction apparatus according to claim 11,
wherein the charging head unit wirelessly supplies electric power to the target object when the target object is supported by being suction-coupled to the suction pad.
